(19) United States
(12) Patent Application Publication
(10) Pub. No.: US 2016/0057572 A1
(43) Pub. Date: Feb. 25, 2016

(54) GEO-FENCING NOTIFICATIONS SUBSCRIPTIONS

(71) Applicant: Microsoft Corporation, Redmond, WA (US)

(72) Inventors: Roberto Bojorquez Alfaro, Bothell, WA (US); Daniel Dole, Seattle, WA (US)

(73) Assignee: Microsoft Corporation, Redmond, WA (US)

(21) Appl. No.: 14/464,042

(22) Filed: Aug. 20, 2014

(51) Int. Cl. H04W 4/02; H04W 12/06

(52) U.S. Cl. CPC H04W 4/021; H04W 12/06

(57) ABSTRACT

Systems and methods disclosed herein may include processing geo-fence related notifications. A current location of a computing device may be determined and a plurality of geo-fences accessible by the computing device may be scanned. Upon detecting the current location is within at least one of the plurality of geo-fences, at least one notification associated with the at least one geo-fence may be acquired. The at least one notification may be displayed at a display of the computing device. The current location may be within a threshold distance of a point of interest, and the at least one notification may provide information about the point of interest. The at least one notification may include a consumer review about the point of interest.

### BACKGROUND

As computing technology has advanced, increasingly powerful mobile devices have become available. For example, smart phones and other computing devices have become commonplace. The mobility of such devices has resulted in different types of functionalities being developed, such as notification-related functionality, which may include various types of text messaging (e.g., Short Message Service (SMS) and Multimedia Messaging Service (MMS)). While the notification-related functionality has many benefits, it is not without its problems. One such problem is that it is often times difficult to obtain useful and timely notifications from a trusted source. For example, a user may post an information request in social media and wait for a response to their request. The response, however, may take a long time and may come from an untrusted source (e.g., a responding user who is unfamiliar to the user posting the request).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a method for processing geo-fence related notifications may include determining a current location of a computing device, and scanning a plurality of geo-fences accessible by the computing device. Upon detecting the current location is within at least one of the plurality of geo-fences, at least one notification associated with the at least one geo-fence may be acquired. The at least one notification may be displayed at a display of the computing device.

In accordance with one or more aspects, a method for processing geo-fence related notifications may include determining a current location of a computing device, and scanning a plurality of available geo-fences accessible by the computing device. Upon detecting the current location is within a threshold distance from at least one of the plurality of geo-fences, a user profile may be identified from a plurality of user profiles. The identified user profile may be associated with the at least one geo-fence. At least one notification within the user profile may be accessed, the at least one notification being associated with the at least one geo-fence. The at least one notification may be automatically displayed upon entry of the at least one geo-fence by the computing device.

In accordance with one or more aspects, a computer-readable storage medium having instructions thereon for processing geo-fence related notifications. The method may include generating a notification for a point of interest. The notification may include one of an audio message, a video message or a text message. A geographic location associated with the point of interest may be selected. A geo-fence may be created for the geographic location, the geo-fence encompassing the point of interest. Attribute information may be designated for the notification. The attribute information may include a privacy setting, where the privacy setting designates the notification as a private notification or a public notification. The attribute information may also include a duration setting designating an expiration date of the notification. The notification, the attribute information and the geo-fence may be stored in a subscription-based user profile, thereby associating the notification with the geo-fence.

As described herein, a variety of other features and advantages can be incorporated into the technologies as desired.

### BRIEF DESCRIPTION OF THE DRAWINGS

FIG. 1 illustrates an example system in which geo-fencing notifications subscriptions discussed herein can be used.

FIG. 2A is a block diagram illustrating an example computing device implementing a geo-fence notification service (“GFNS”), in accordance with one or more embodiments.

FIG. 2B is a more detailed block diagram of the example computing device of FIG. 2A, implementing the geo-fence notification service (“GFNS”), in accordance with one or more embodiments.

FIG. 2C is a block diagram of location determination modules, which may be used by the example computing device of FIG. 2A, in accordance with one or more embodiments.

FIG. 3 illustrates an example user interface that can be displayed to a user to allow the user to select whether locations are to be determined in accordance with one or more embodiments.

FIG. 4 is a diagram of a geo-fence notification service, in accordance with one or more embodiments.

FIG. 5 is a diagram illustrating functionalities associated with a posting user and a subscribing user of a geo-fence notification service, in accordance with one or more embodiments.

FIGS. 6-8 are flow diagrams illustrating example processing of geo-fence related notifications, in accordance with one or more embodiments.

FIG. 9 is a diagram of an example computing system, in which some described embodiments can be implemented.

FIG. 10 illustrates a generalized example of a suitable cloud-supported environment, in which described embodiments, techniques, and technologies may be implemented.

FIG. 11 is an example mobile device that can be used in conjunction with the technologies described herein.

### DETAILED DESCRIPTION

Mobile devices may use location-based functionality, in which certain actions are taken by the device based on the location of the device. Such location-based functionality (e.g., location-based alerts) are given by creating (or pre-defining) one or more geo-fences on the device and associating certain actions to be performed when the device enters and/or exits the pre-defined geo-fences.

Providing location-based alerts (or geo-fencing) is a common functionality on mobile devices that allows users to specify user-defined actions when the device enters and/or exits certain user-specified locations (e.g., show reminder when the device has entered a home location). This functionality requires the device location platform to periodically acquire the current location of the device to check against pre-registered geo-fences. In some instances, the geo-fence tracking can either be performed natively by a dedicated GPS hardware processor (e.g., a GPS SoC), or it can be performed by the location platform running on the device application processor (AP). Hardware geo-fencing (i.e., geo-fence tracking on a GPS SoC) is highly power-efficient because the continuous location tracking occurs on a low-power processor and the main AP wakes up only for handling location-based alerts.

As described herein, various techniques and solutions can be applied so that timely and useful notifications may be provided using geo-fences. More specifically, a posting user (or a “poster”) can post a notification (e.g., a message such as a text message, a voice message, a video message, a photo, and so forth) related to a real-world location (e.g., a point-of-interest or POI). A geo-fence may be created for the POI and the notification may be associated with the geo-fence. The notification may be shown to other users (or a “consumer”) of the system (e.g., automatically pushed and displayed at the other user's device) when (1) the consumer physically crosses the geo-fence associated with the notification, and (2) the consumer has subscribed to receive notifications from the posting user. The subscription model enables consumers to only get notifications posted by user the consumer has actively selected and subscribed to.

A user may post a notification associated with a given POI, create a geo-fence encompassing the POI and associate the notification with the geo-fence. Additionally, the posting user may designate the notification to be public (i.e., any consumer that enters the geo-fence associated with the notification will receive the notification automatically) or private (only consumers subscribing to the posting user will receive the notification upon entering the geo-fence associated with it). The posting user may also designate the notification to apply only for a specific sub-set of users that subscribe to notifications from the posting user.

In some instances, ratings may be assigned to the posting users (e.g., by the posting user's subscribers) resulting in a self-regulated environment, in which users posting the most interesting and better quality messages would continue to get subscriptions, while low quality posting users would eventually be left with a few or no followers. For public notifications from a given posting user, a rate/review model may be used, based on the total number of followers/subscribers to the posting user (e.g., the posting users with the most followers/subscribers may be listed or otherwise made public).

The above geo-fence based notifications may be part of a geo-fence notification service (“GFNS”), which may be implemented as a stand-alone application (or app), as part of an existing map-related application, and/or as part of a device operating system (“OS”).

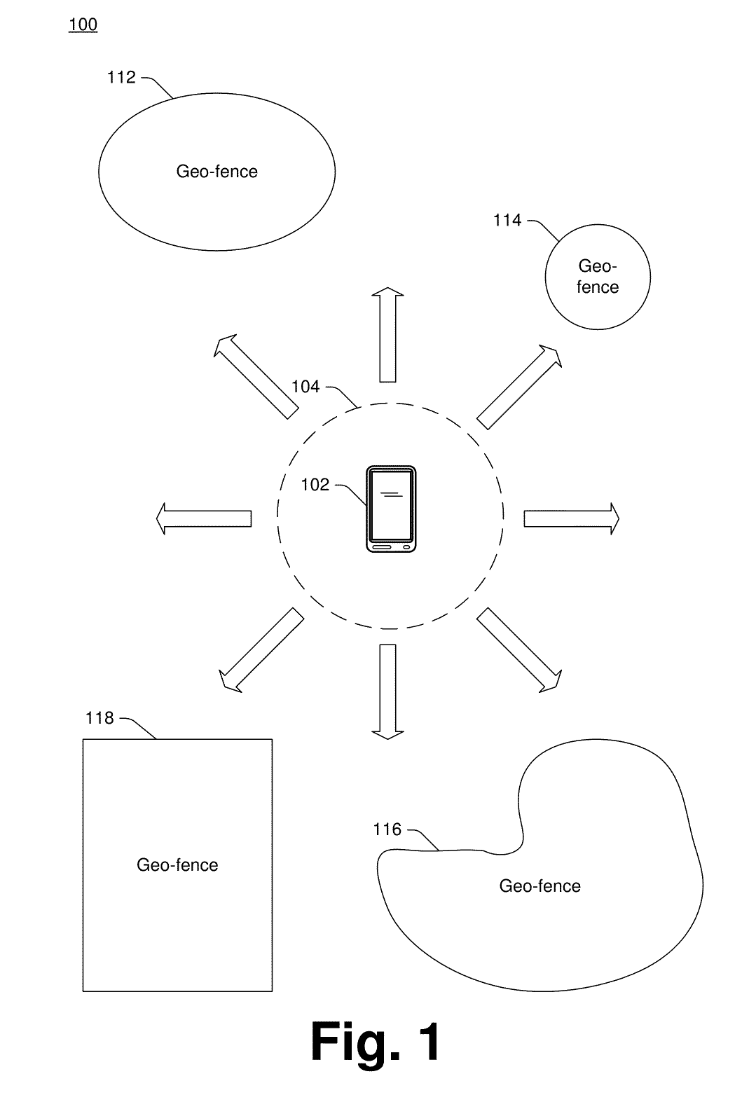

FIG. 1 illustrates an example system 100 in which geo-fencing notifications subscriptions discussed herein can be used. The system 100 includes a computing device 102, which can be any of a variety of types of devices, although typically is a mobile device. For example, the computing device 102 can be a smart phone or other wireless phone, a laptop or netbook computer, a tablet or notepad computer, a wearable computer, a mobile station, an entertainment appliance, an audio and/or video playback device, a game console, an automotive computer, and so forth. The computing device 102 is typically referred to as being a mobile device because the device 102 is designed or intended to be moved to multiple different locations (e.g., taken by a user with him or her as the user goes to different locations).

The location of the computing device 102 can be determined using any of a variety of different techniques, such as wireless networking (e.g., Wi-Fi) triangulation, cellular positioning, Global Navigation Satellite System (GNSS) positioning such as GPS signal-based positioning, network address (e.g., Internet Protocol (IP) address) positioning, and so forth as discussed in more detail below. Different location determination techniques can have different accuracy errors or associated uncertainties. For example, a location determination technique may be accurate to 10 meters (m) or 10 kilometers (km). The exact position of the computing device 102 is thus not pinpointed, but is illustrated as an area 104 surrounding the computing device 102. The area 104 represents the uncertainty in the determined location or position of the computing device 102, so although the computing device is determined to be at a particular location or position (e.g., approximately the center of the area 104), the computing device 102 may actually be anywhere within the area 104.

The system 100 also illustrates multiple geo-fences 112, 114, 116, and 118. Each geo-fence 112-118 can be any of a variety of different places of interest to the computing device 102, to the user of the computing device 102, to a program (e.g., an app) running on the computing device 102, and so forth. For example, a geo-fence 112-118 can be the user's home, the user's workplace, restaurants or businesses that may be visited by the user, educational facilities, public services (e.g., hospitals or libraries), geographic places (e.g., cities or states), and so forth.

The location of geo-fences 112-118 is maintained in, or otherwise accessible to, the computing device 102. It should be noted that different users of the computing device 102 can optionally have different geo-fences maintained or accessed. In some instances, any of the geo-fences 112-118 may be stored (e.g., in a network or cloud storage) and may be made part of a profile of a user (e.g., a posting user) who is responsible for creating them. In this regard, some of the geo-fences 112-118 may be designated as public and, therefore, made available (i.e., accessible) to the device 102 as well as to any other device. Other geo-fences, however, may be designated (and stored within the posting user's profile) as private and access to such geo-fences may be based on, for example, a subscription to the posting user's profile associated with the private geo-fences.

The computing device 102 is mobile and can enter and exit geo-fences 112-118. At any given time, the computing device 102 can be within one of geo-fences 112-118, or within no geo-fence. If the computing device 102 is determined to be within the area that encompasses a particular geo-fence, then the computing device 102 is referred to as being inside or within that particular geo-fence. However, if the computing device 102 is determined to not be within the area that encompasses a particular geo-fence, then the computing device 102 is referred to as being outside or not within that particular geo-fence. Situations can also arise in which two or more geo-fences overlap, in which case the computing device 102 can be within two or more geo-fences 112-118 at one time. It should be noted that the illustration of FIG. 1 is not to scale, and that geo-fences 112-118 can be, and typically are, significantly larger in size than the computing device 102.

In the illustrated example, the area 104 does not intersect any of the geo-fences 112-118, and thus the computing device 102 is outside each of the geo-fences 112-118. However, if the area 104 were to at least partially overlap one of the geo-fences 112-118, then the computing device 102 is possibly inside the geo-fence that is overlapped. Whether the computing device 102 is determined to be inside the geo-fence or outside the geo-fence in such situations can be determined in various manners, such as based on the presence of an overlap, how much of the geo-fences overlap, and so forth. If the computing device 102 enters a geo-fence, geo-fence based notification may be triggered, as explained in greater detail herein.

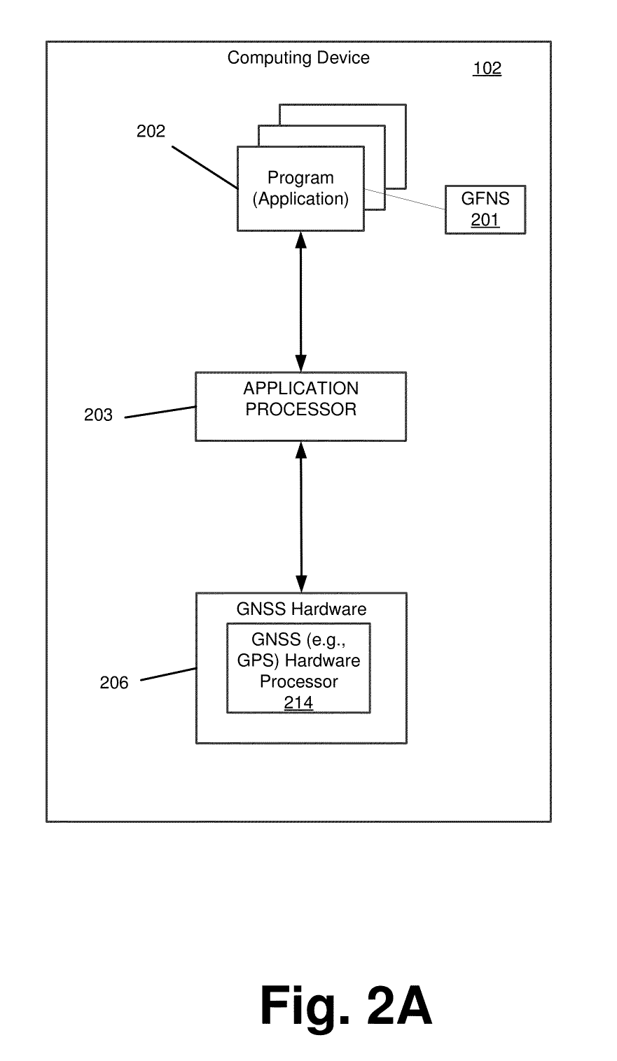

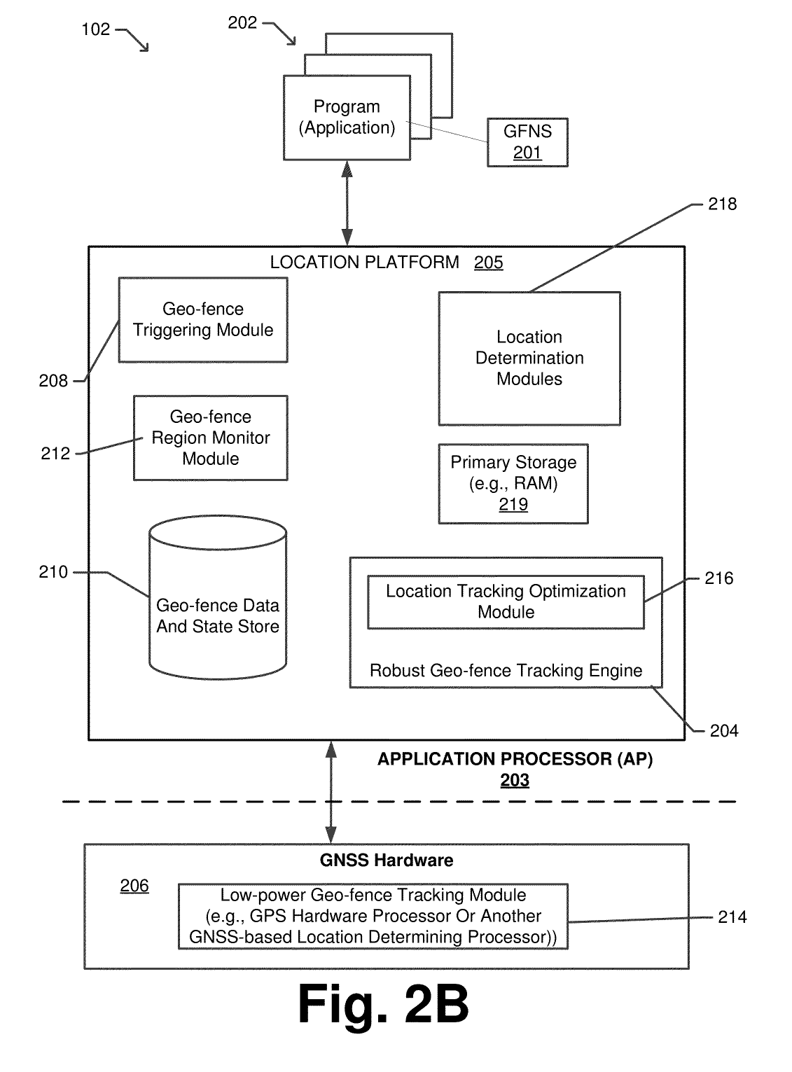

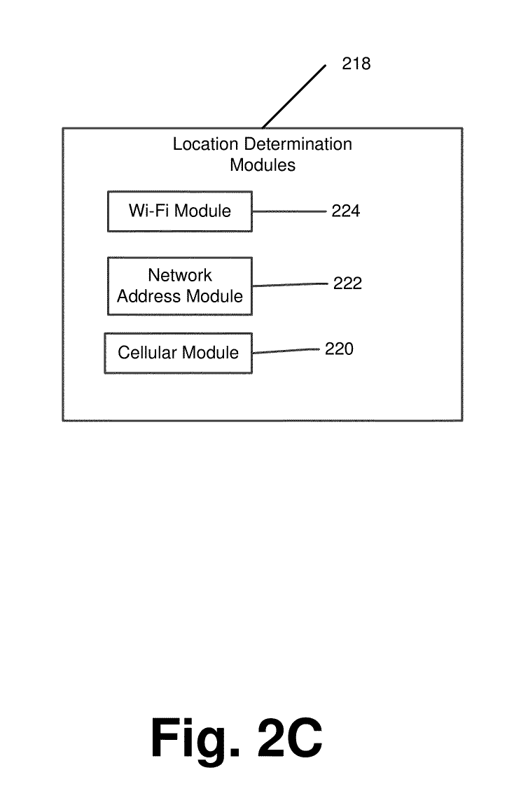

FIG. 2A is a block diagram illustrating an example computing device implementing a geo-fence notification service (“GFNS”), in accordance with one or more embodiments. Referring to FIG. 2A, the computing device 102 may comprise one or more programs (or applications) 202, an application processor (AP) 203, and GNSS hardware 206. The AP 203 may be a central processing unit (CPU) of the device 102.

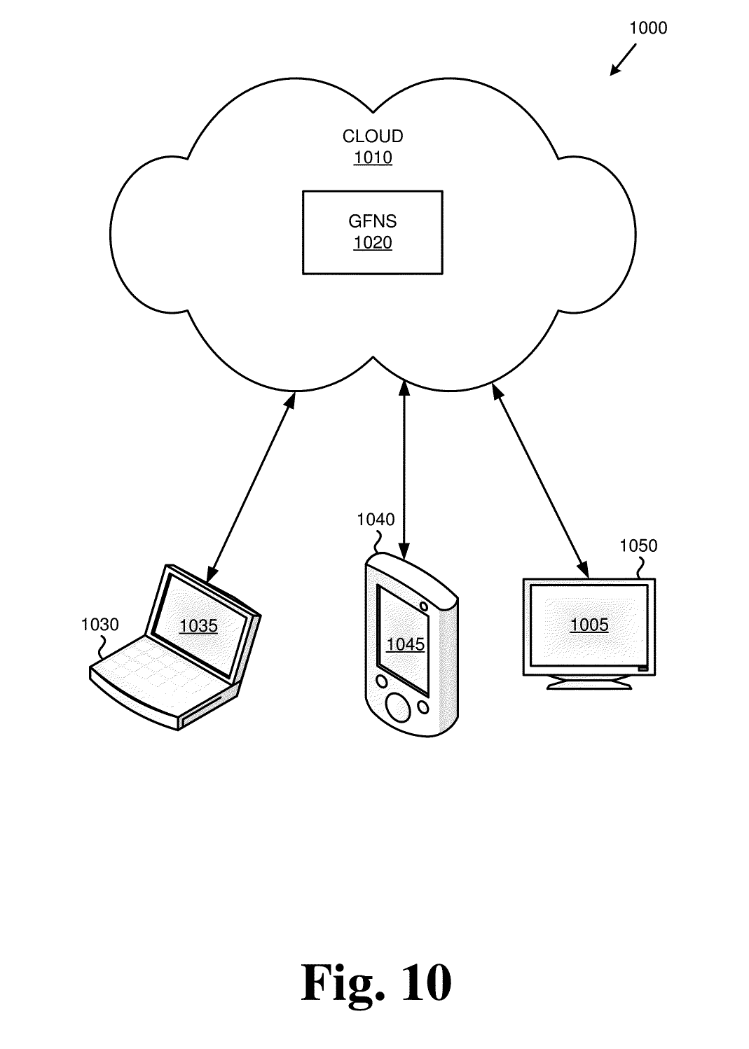

The one or more programs 202 can include various different types of programs, such as applications (or apps), operating system modules or components, which may be executing on the device 102 using the AP 203. In example embodiments, one or more of the programs 202 may implement a geo-fence notification service (GFNS) 201 with the functionalities described herein. For example, the GFNS 201 may comprise suitable logic, circuitry, interfaces, and/or code and may be operable to provide a posting user the functionalities to create a profile, post notifications in connection with, e.g., points-of-interest (POIs), create one or more geo-fences for the POIs, associating the notifications with one or more of the geo-fences created for the corresponding POI the notification is about, designate a privacy level for the notifications (e.g., public or private), allow other users to subscribe to the posting user's profile (thereby have access to the private notifications of that posting user), and so forth. The GFNS 201 may provide a consuming user (or subscriber) to subscribe to one or more profiles of posting users in order to have access to the private notifications posted by such users, access one or more public notifications associated with a geo-fence without the need to subscribe to the posting user's profile, and so forth. One or more aspects of the GFNS (e.g., profile creating functionalities including setting up notifications and associated geo-fences) may be implemented within the device 102 (e.g., as one of the stand-alone applications 202, as part of an existing application (such as mapping/navigation application), and/or as part of the device OS). However, some other functionalities of the GFNS 201 (e.g., geo-fence storage or storage of other data associated with the posting user's profile) may be implemented in a network storage (e.g., cloud storage as seen in FIG. 10) outside the device 102.

The AP 203 may comprise suitable circuitry, logic, and/or code and may be operable to provide a location platform (as further explained in reference to FIG. 2B) for managing geo-fence-related functionalities. Such geo-fence-related functionalities may include setting-up new geo-fences, receiving geo-fences (e.g., from the one or more programs 202 including the GFNS 201), tracking geo-fences, and providing one or more breach alerts (e.g., providing entry or exit alerts back to the one or more programs 202 or the GFNS 201 in order to trigger one or more notifications associated with a geo-fence the device has entered) upon a state change of a given geo-fence. For example, the AP 203 may implement a robust geo-fence tracking engine (see e.g., FIG. 2B) for tracking geo-fences. The AP 203 may also implement additional modules to assist the location platform 205 with various other functionalities as described in greater detail below in reference to FIGS. 2B-2C.

The GNSS hardware 206 may be a dedicated (e.g., system-on-a-chip (“SoC”)) hardware platform providing low-power navigation-related functionalities, such as tracking of geo-fences. In some instances, the GNSS hardware 206 may implement a GNSS (e.g., GPS) hardware processor 214 (running a GPS engine), which may be used to track geo-fences using a GNSS location signal (e.g., a GPS signal). For simplicity, the GNSS hardware processor 214 will be referred to as a GPS hardware processor 214, but other GNSS-based processors may also be used for implementing the hardware processor 214.

In an example embodiment, the one or more programs 202 may interact with the AP 203 (e.g., with the location platform implemented by the AP 203) to create geo-fences (or receive geo-fences, such as from external storage) and receive entry/exit notifications as the device 102 moves in and out of geo-fences. The one or more programs 202 can choose to receive a subset of event notifications (e.g., either entry or exit) or all event notifications. For example, the GFNS 201 may receive geo-fence entry notifications so as to trigger communication of the notification associated with the entered geo-fence to the subscribing user (or cause display the notification at device 102, if the subscribing user is using the device 102 to receive geo-fence based notifications from posting users).

Initially, for geo-fences that have to be tracked, the location platform implemented by the AP 203 pushes the geo-fences to the GPS hardware processor 214 for geo-fence tracking, with the assumption that the GPS signal condition is of good quality. Under normal signal conditions, the GPS hardware processor 214 can track the geo-fences at low-power, even when the AP 203 is inactive. The GPS hardware processor 214 may wake up the AP 203 when a geo-fence event (e.g., an entry or exit event) is triggered due to device movement. However, in instances when the GPS signal conditions deteriorate and the GPS hardware processor 214 is unable to reliably track geo-fences, geo-fence tracking may be performed by the geo-fence tracking engine implemented by the AP 203.

FIG. 2B is a more detailed block diagram of the example computing device of FIG. 2A, implementing the geo-fence notification service (“GFNS”), in accordance with one or more embodiments. Referring to FIG. 2B, the computing device 102 may comprise one or more programs (or applications) 202, an application processor (AP) 203, and GNSS hardware 206 (e.g., GPS hardware processor 214). The AP 203 may implement a location platform 205, which may be used to provide navigation and geo-fence managing and tracking functionalities, for example. The AP 203 may be part of the CPU processing core of the device 102, and the GNSS hardware 206 may be implemented separately from the device CPU (e.g., as a SoC GNSS platform, such as a GPS SoC).

The location platform 205 can be implemented by a single device such as the computing device 102 of FIG. 1, or alternatively multiple devices such as the computing device 102 and one or more server computers accessed via a network (e.g., a cellular or other wireless phone network, the Internet, etc.). The location platform 205 includes one or more location determination modules 218, a geo-fence region monitor module 212, a robust geo-fence tracking engine 204, a geo-fence triggering module 208, geo-fence data and state store 210, and primary storage (e.g., RAM) 219.

The geo-fence data and state store 210 maintains various data used by the techniques discussed herein. The geo-fence data and state store 210 can be implemented using any of a variety of different storage devices, such as system memory (e.g., random access memory (RAM)), Flash memory or other solid state memory, magnetic disks, optical discs, and so forth. Even though a separate primary storage 219 is illustrated in FIG. 2B, the present disclosure may not be limited by the type or configuration of memory used. For example, the primary storage 219 and the geo-fence data and state store 210 may be implemented together. In addition, the device 102 may use a secondary storage comprising hard disk drive storage, optical drive storage, and/or flash memory storage. Such secondary storage may be implemented as part of the device 102 or may be implemented remotely from the device 102. Additionally, the primary storage 219, the geo-fence data and state store 210 and any secondary storage (if available for use by the device 102) may be shared between the GPS hardware processor 214 and the AP 203 (e.g., by any of the modules within the location platform 205).

The data maintained in the geo-fence data and state store 210 identifies multiple geo-fences, including geo-fence data for each of multiple geo-fences. Geo-fence data can be obtained from various sources, such as from a distributer or reseller of the geo-fence data and state store 210 that stores the data on the data store 210, from a program running on a computing device implementing the location platform 205 (e.g., from the one or more programs 202), from another device or service, and so forth. The geo-fence data for a geo-fence may describe the boundary of the geo-fence, the criteria to be satisfied in order for the geo-fence to be triggered, as well as one or more states associated with a given geo-fence. In example embodiments, the GFNS 201 may use the geo-fence data and state store 210 to store geo-fence data for one or more geo-fences set up by a posting user. In this regard, geo-fences associated with various notifications set up by a posting user using the GFNS 201 may be tracked using the geo-fence data and state store 210, and the corresponding notification associated with the tracked geo-fence may be triggered upon entry within the tracked geo-fence.

The criteria to be satisfied can refer to a device entering the geo-fence, exiting the geo-fence, staying within the geo-fence for a particular amount of time (e.g., at least a threshold amount of time, no more than a threshold amount of time, etc.), a time period for the geo-fence (e.g., a start time and end time, a start time and a duration), combinations thereof, and so forth. One or more actions that are taken in response to the geo-fence being triggered (the criteria being satisfied) can also be included as part of the geo-fence data. Any of a variety of actions can be taken when a geo-fence is triggered, such as a particular program being notified, particular content being displayed or otherwise played back by the computing device, the geo-fence data being deleted from the geo-fence data and state store 210, combinations thereof, and so forth. Multiple different actions can be taken based on the manner in which the geo-fence is triggered, such as one action taken in response to the device entering the geo-fence, and another action taken in response to the device exiting the geo-fence.

The boundary of the geo-fence can be specified in any of a variety of different manners. For example, the geo-fence can be specified as a position (e.g., latitude and longitude coordinates) and a radius, as a set of positions (e.g., latitude and longitude coordinates of corners of the geo-fence), as a series of vectors, and so forth. In the discussions herein, reference is made to the geo-fences being approximately circular in shape. However, it should be noted that the geo-fences can be any of a variety of regular geometric shapes (e.g., triangles, rectangles, octagons, and so forth), other geometric shapes (e.g., freeform shapes or blobs), and so forth.

The geo-fence state information stored in the geo-fence data and state store 210 may comprise, for example, an INSIDE or OUTSIDE state for one or more of the geo-fences that are being maintained by the device 102. For a given geo-fence, an INSIDE state indicates that the device 102 is within the boundaries of the geo-fence, and an OUTSIDE state indicates that the device 102 is outside the boundaries of the particular geo-fence.

The geo-fence data and state store 210 is illustrated in FIG. 2B as being part of the location platform 205. It should be noted that the data maintained in the geo-fence data and state store 210 can be obtained from the programs 202 (e.g., from the programs 202 as they are loaded in the computing device 102 implementing the location platform 205). Alternatively, one or more of the programs 202 can include a data store that is used in addition to, or in place of, the geo-fence data and state store 210.

The geo-fences can be used in a variety of different manners. For example, a geo-fence and action to be taken can be to alert a user of the computing device 102 implementing at least part the location platform 205 when they are approaching a bus stop, to give the user a coupon when they enter a shopping mall or store, to notify a parent when their child has left school or entered their home, to display weather information for a current location when the user travels to a different city, and so forth. In other example embodiments, geo-fence based notifications managed by the GFNS 201 may use the location platform 205 to track one or more geo-fences and/or detect entry within a geo-fence to trigger display (or communication outside the device 102) of one or more notifications associated with the entered geo-fence.

The location determination modules 218 may comprise suitable circuitry, logic, and/or code and may be operable to determine the location of the computing device 102. A more detailed diagram of the location determination modules 218 is illustrated in FIG. 2C.

FIG. 2C is a block diagram of location determination modules, which may be used by the example computing device of FIG. 2A, in accordance with one or more embodiments. Referring to FIGS. 2B-2C, the location determination modules 218 may include a Wi-Fi module 224, a network address module 222, and a cellular module 220. It should be noted, however, that the modules 220-224 are examples and that the location determination modules 218 need not include each of the modules 220-224 and/or that the location determination modules 218 can include one or more additional modules that determine a location of the computing device 102 in different manners. For example, the location determination modules 218 can include MEMS (Micro-electromechanical systems), cameras, microphones, and so forth. Determining which of the location determination modules 218 is invoked, and when one or more of the location determination modules 218 is invoked, may be based on, for example, current device power requirements.

It should be noted that the location determination modules 218 consume power, and that different amounts of power can be consumed by different ones of the location determination modules 218. If a location determination module A consumes more power than a location determination module B, the location determination module A is referred to as being the higher power location determination module and the location determination module B is referred to as being the lower power location determination module.

The Wi-Fi module 224 uses Wi-Fi signals, such as triangulation of Wi-Fi signals, to determine the location of the computing device 102. The Wi-Fi module 224 can receive signals from various wireless access points, including an identifier of a particular wireless access point and/or a particular wireless network from which a signal is received. For example, a wireless access point may send a media access control (MAC) address of the wireless access point, a basic service set identifier (BSSID) of a wireless network supported by the wireless access point, and so forth. The Wi-Fi module 224 can also measure a strength (e.g., received signal strength indicator (RSSI) values) of these received signals. It should be noted that the Wi-Fi module 224 can, at any given time for any given position of the computing device, receive signals from multiple wireless access points. The Wi-Fi module 224 can maintain or otherwise access a record of wireless access points, signal strengths, and corresponding locations to determine the location of the computing device at any particular time given the wireless access points from which signals are received and the strength of those signals at the particular given time. Alternatively, the Wi-Fi module 224 can provide an indication of the wireless access points from which signals are received and the strength of those signals at a particular given time to a remote service (e.g., accessed via any of a variety of different types of networks) that determines and returns to the Wi-Fi module 224 an indication of the location of the computing device at that particular given time.

The network address module 222 uses network address positioning to determine the location of the computing device 102. The network address used can be any of a variety of network addresses, such as the IP address of the computing device. The network address module 222 can maintain or otherwise access a record of IP addresses or address ranges and corresponding locations to determine the location of the computing device at any particular time given the IP address assigned to the computing device at the particular given time. Alternatively, the network address module 222 can provide an indication of the IP address of the computing device at a particular given time to a remote service (e.g., accessed via any of a variety of different types of networks) that determines and returns to the network address module 222 an indication of the location of the computing device at that particular given time.

The cellular module 220 uses cellular positioning to determine the location of the computing device 102. The cellular module 220 can receive signals from various cell transceivers, including an identifier of a particular cell transceiver (e.g., a cell tower or transceiver identifier), from which a signal is received. The cellular module 220 can also measure a strength of these received signals. It should be noted that the cellular module 220 can, at any given time for any given position of the computing device, receive signals from multiple cell transceivers. The cellular module 220 can maintain or otherwise access a record of cell transceivers, signal strengths, and corresponding locations to determine the location of the computing device at any particular time given the cell transceivers from which signals are received and the strength of those signals at the particular given time. Alternatively, the cellular module 220 can provide an indication of the transceivers, from which signals are received and the strength of those signals at a particular given time to a remote service (e.g., accessed via any of a variety of different types of networks) that determines and returns to the cellular module 220 an indication of the location of the computing device at that particular given time.

Although illustrated as modules separate from the location determination modules 218, it should be noted that one or more of the modules 220-224 can alternatively be implemented at least in part in one of the location determination modules 218. For example, at least part of one or more of the modules 220-224 can be implemented in hardware components as part of the GNSS hardware 206.

The locations determined by the location determination modules 218 are typically latitude and longitude coordinates, although the location can alternatively be specified in other manners. Each of the location determination modules 218 has an associated uncertainty in the location that it determines, also referred to as an accuracy error or estimated accuracy error of the location. The amount of this uncertainty can be determined in various manners, such as being reported by the location determination module itself, being pre-configured in or otherwise accessible to other modules of the location platform 205 (e.g., by the robust geo-fence tracking engine 204), and so forth. The uncertainty results in a position uncertainty area for the location determined by a location determination module, the position uncertainty area being an area within which the computing device 102 may actually be for the determined location.

The geo-fence region monitor module 212 may comprise suitable circuitry, logic, and/or code and may be operable to determine whether one or more of the geo-fences identified in the geo-fence data and state store 210 is triggered. Data for numerous different geo-fences can be maintained in the geo-fence data and store 210, and one or more of those geo-fences may be selected by the geo-fence region monitor module 212. The geo-fence region monitor module 212 can make the determination in a variety of different manners, such as based on a current distance between the geo-fences and the computing device 102 (e.g., the distance between a currently determined location of the computing device 102 and a location on the edges (or alternatively other portions) of the geo-fences), based on sizes of (areas encompassed by) the geo-fences, based on the geo-fence tracking parameters as discussed in more detail below, and so forth. The one or more geo-fences that are determined by the geo-fence region monitor module 212 are those deemed more likely to be entered or exited based on various criteria, such as the current location of the computing device 102, and those one or more geo-fences can be the focus of the geo-fence region monitor module 212 until the criteria changes. However, it should be noted that the geo-fence region monitor module 212 can determine whether a geo-fence is triggered for any of the geo-fences in the geo-fence data and state store 210.

The robust geo-fence tracking engine 204 may comprise suitable circuitry, logic, and/or code and may be operable to obtain a current location of the computing device at regular or irregular intervals, and detects whether a geo-fence event occurs. These intervals can be selected dynamically based on current conditions (e.g., approximate distance to a closest geo-fence, power budget for the computing device, an estimated speed of movement of the computing device, and so forth). The robust geo-fence tracking engine 204 may also comprise a location tracking optimization module 216 that determines when to invoke (e.g., activate) one or more of the location determination modules 218 to obtain the location of the computing device. The location tracking optimization module 216 may take into account various power saving techniques in determining which location determination module 218 to invoke and/or when to invoke a location determination module 218.

The term “geo-fence event” may refer to the device 102 entering the geo-fence, exiting the geo-fence, or staying in the geo-fence for a particular amount of time (e.g., being in the geo-fence and not exiting the geo-fence). The robust geo-fence tracking engine 204 may be operable to evaluate the uncertainty associated with the determined location relative to the size of the geo-fence in order to determine whether the computing device 102 is inside the geo-fence or outside the geo-fence. The robust geo-fence tracking engine 204 may also track whether the computing device 102 is inside or outside the geo-fence over time, and thus knows whether the computing device 102 has moved from inside the geo-fence to outside the geo-fence, whether the computing device 102 has moved outside the geo-fence to inside the geo-fence, an amount of time that the computing device has been inside the geo-fence, and so forth.

The geo-fence triggering module 208 may comprise suitable circuitry, logic, and/or code and may be operable to analyze criteria to be satisfied in order for a geo-fence to be triggered, and to determine whether the criteria are satisfied. This determination is made at least in part on the occurrence of one or more geo-fence events as determined by the robust geo-fence tracking engine 204. In response to the criteria being satisfied, the module 208 determines that the geo-fence is triggered and takes the appropriate action. The action taken can be associated with geo-fence data for the triggered geo-fence stored in the geo-fence data and state store 210, or can be determined in other manners such as being pre-configured in the geo-fence triggering module 208, being obtained from another module or device, and so forth.

In one or more embodiments, the action taken by the geo-fence triggering module 208 in response to the geo-fence being triggered is to notify the one or more programs 202, including the GFNS 201. The one or more programs 202 can include various different types of programs, such as applications, operating system modules or components, and so forth. The one or more programs 202 to be notified can be identified in different manners, such as being configured in the geo-fence triggering module 208, being identified as part of the geo-fence data for the geo-fence in the geo-fence data and state store 210, being obtained from another module or service, and so forth. A program 202 can be notified of the geo-fence event that occurred by, for example, communicating a breach alert to the program 202 upon the occurrence of a geo-fence event (e.g., geo-fence enter or exit event), as well as optionally additional information (e.g., that the computing device 102 was within a geo-fence for at least a threshold amount of time). The program 202 can then take the action it desires based on the geo-fence being triggered. For example, the geo-fence triggering module 208 may notify the GFNS 201 that the device 102 has crossed a geo-fence associated with a notification, automatic display of the notification (e.g., at a display of device 102) may be initiated (or initiating another type of alert, such as visual or audible alert of available notification).

In one more embodiments, a location is determined by the location determination modules 218 only after receiving user consent to do so. This user consent can be an opt-in consent, where the user takes an affirmative action to request that the location be determined by the location determination modules 218 before any such location is determined. Alternatively, this user consent can be an opt-out consent, where the user takes an affirmative action to request that the location not be determined by the location determination modules 218. If the user does not choose to opt out of determining the location, then it is an implied consent by the user to determine his or her location. Furthermore, it should be noted that the location determined by the location determination modules 218 can be maintained in a computing device receiving the determined location (e.g., the computing device 102 of FIG. 1) and need not be communicated to other devices or services.

Alternatively, user consent may be granted for specific programs and revoked for other programs. In this case, location information will be determined only when the user has consented for at least one program for which geo-fence tracking is used. The location information is used to determine the entry and/or exit of only those geo-fences belonging to the consented programs. Remaining geo-fences from the unapproved programs are not tracked.

The GNSS hardware 206 may be a dedicated (e.g., system-on-a-chip, or SoC) hardware platform providing low-power navigation-related functionalities, such as tracking of geo-fences. Additionally, the GNSS hardware 206 may comprise a low-power geo-fence tracking module 214, which may be used to track one or more geo-fences using at least one navigation signal.

The low-power geo-fence tracking module 214 may comprise suitable circuitry, logic, and/or code and may use GNSS positioning to determine the location of the computing device 102. The location of the computing device 102 may be determined based on a particular number of satellites (e.g., four or more satellites) from which the low-power geo-fence tracking module 214 can receive signals or otherwise communicate. The low-power geo-fence tracking module 214 can implement the GNSS functionality using a variety of different technologies, including but not limited to the Global Positioning System (GPS), the Global Navigation Satellite System (GLONASS), the BeiDou (or Compass) navigation system, the Galileo positioning system, combinations thereof, and so forth. In this regard, the GNSS hardware 206 may implement, for example, a GPS hardware processor as the low-power geo-fence tracking module 214, as illustrated in FIGS. 2A-2B and with functionalities discussed herein.

Even though discussions herein may refer to the low-power geo-fence tracking module 214 as the GPS hardware processor 214, this is only one example implementation of the low-power geo-fence tracking module. The GNSS hardware 206 may implement other types of low-power hardware navigation engines as well (e.g., the low-power geo-fence tracking module 214 may be implemented as a GLONASS, a BeiDou (or Compass) navigation system, a Galileo positioning system, or another type of navigation system and/or combinations thereof. Additionally, the low-power geo-fence tracking module 214 operates in any of a variety of public and/or proprietary manners to determine, given the one or more satellites from which the low-power geo-fence tracking module 214 can receive signals or otherwise communicate at any particular given time, the location of the computing device 102 at that particular given time. In an example embodiment, the GNSS hardware 206 (e.g., the low-power geo-fence tracking module 214) may also be adapted to use numerous complementary location determination techniques to detect the device's location, even in instances when the GPS signal has deteriorated. Such location determination techniques may include wireless networking triangulation, cellular positioning, and/or network address positioning.

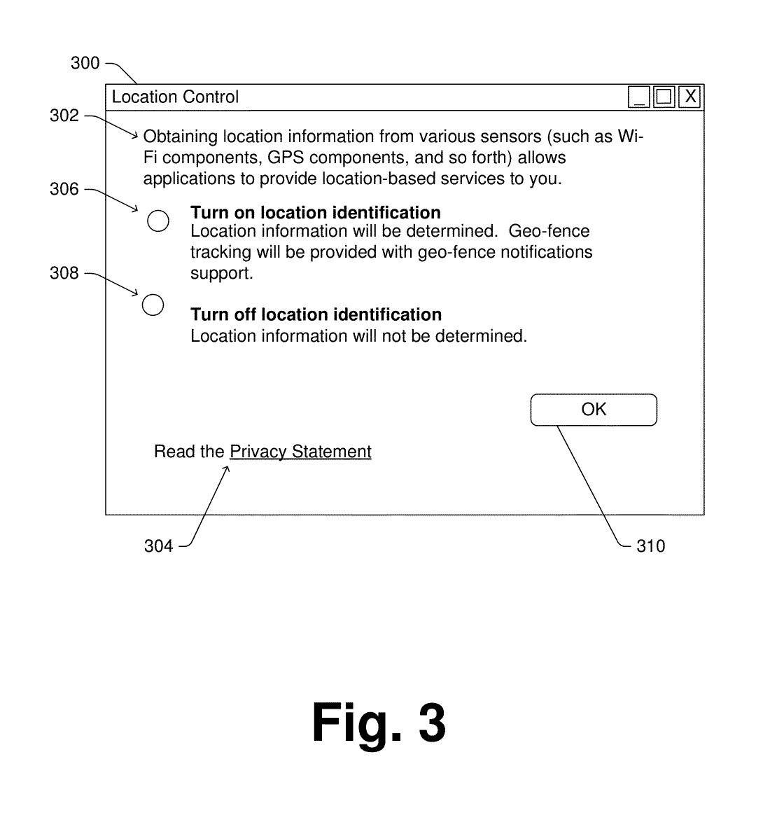

FIG. 3 illustrates an example user interface that can be displayed to a user to allow the user to select whether locations are to be determined in accordance with one or more embodiments. A location control window 300 is displayed including a description 302 explaining to the user why the location information is being determined A link 304 to a privacy statement is also displayed. If the user selects the link 304, a privacy statement of the system 200 is displayed, explaining to the user how the user's information is kept confidential.

Additionally, the user is able to select a radio button 306 to opt-in to the determining of location information including geo-fence tracking with geo-fence based notifications support, or a radio button 308 to opt-out of the determining of location information. Once a radio button 306 or 308 is selected, the user can select an “OK” button 310 to have the selection saved. In instances when radio button 306 is selected, geo-fence tracking may be activated with failover support as described herein. It is to be appreciated that radio buttons and an “OK” button are only examples of user interfaces that can be presented to a user to opt-in or opt-out of the determining of location information, and that a variety of other conventional user interface techniques can alternatively be used. The location platform 205 of FIG. 2B may then proceed to determine the location of the computing device (and track one or more geo-fences for purposes of providing geo-fence based notifications), or not determine the location of the computing device (and not track any geo-fences), in accordance with the user's selection.

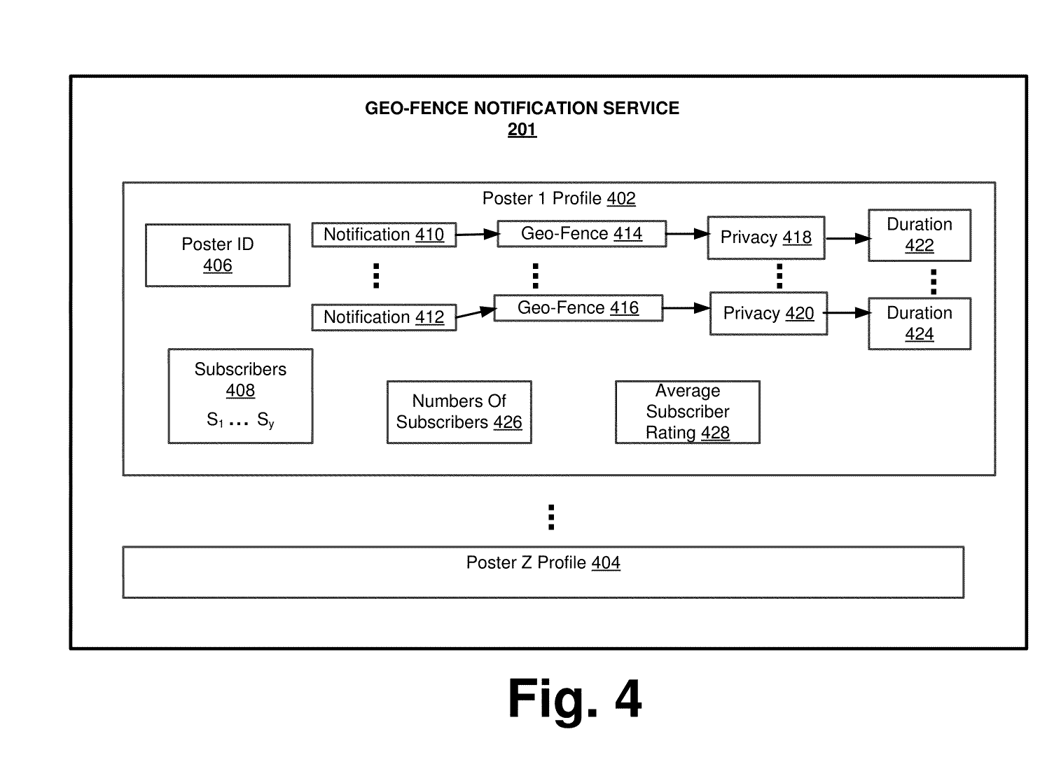

FIG. 4 is a diagram of a geo-fence notification service, in accordance with one or more embodiments. Referring to FIG. 4, the GFNS 201 may comprise suitable logic, circuitry, interfaces, and/or code and may be operable to maintain one or more profiles 402, . . . , 404 of posting users 1, Z, respectively. An example posting user profile 402 may comprise identification information (ID) 406 of the posting user, a plurality of notifications 410, . . . , 412 entered by the posting user and a corresponding plurality of geo-fences 414, . . . , 416. The profile 402 may further include privacy settings 418, . . . , 420 and duration settings 422, . . . , 424 for the corresponding notifications 410, . . . , 412.

The poster ID 406 may include information identifying the poster, such as social media web site identification (or handle) or any other information identifying the poster. The notifications 410, . . . , 412 may include audio, video and/or text notifications (or messages) entered by the poster and associated with, for example, one or more geographic locations (e.g., a point-of-interest (POI) location). The geo-fence 414, . . . , 416 may include geo-fences that have been set up (or activated) by the poster, and are associated with the same geographic area (or POI) as the corresponding notifications 410, . . . , 412. The privacy settings 418, . . . , 420 may designate the corresponding notifications 410, . . . , 412 as, e.g., private or public. If a notification is designated as private, then only a subscribing user may have access to such notification. If a notification is designated as public, then either a subscribing or a non-subscribing user may have access to such notification. The duration settings 422, . . . , 424 may designate a time during which the corresponding notifications 410, . . . , 412 are active and available for access. After the duration time has expired, the corresponding notification (as well as the corresponding geo-fence) may be deleted from the profile 402.

The profile 402 may also include a list 408 of subscribers (e.g., subscribers S1, . . . , Sy to the profile 402) and number of subscribers 426. The number of subscribers 426 may be used as a rating of the posting user (e.g., the more popular the poster 1 with profile 402 is, the more subscribers the user will have). In some embodiments, the subscribing users may leave a rating (e.g., one through five stars or any other type of rating), and an average rating 428 based on all recorded subscribing users' ratings may be calculated. The number of subscribers 426 and/or the average subscriber rating 428 may be made available to potential subscribing users for purposes of determining whether to subscribe to notifications from the current user.

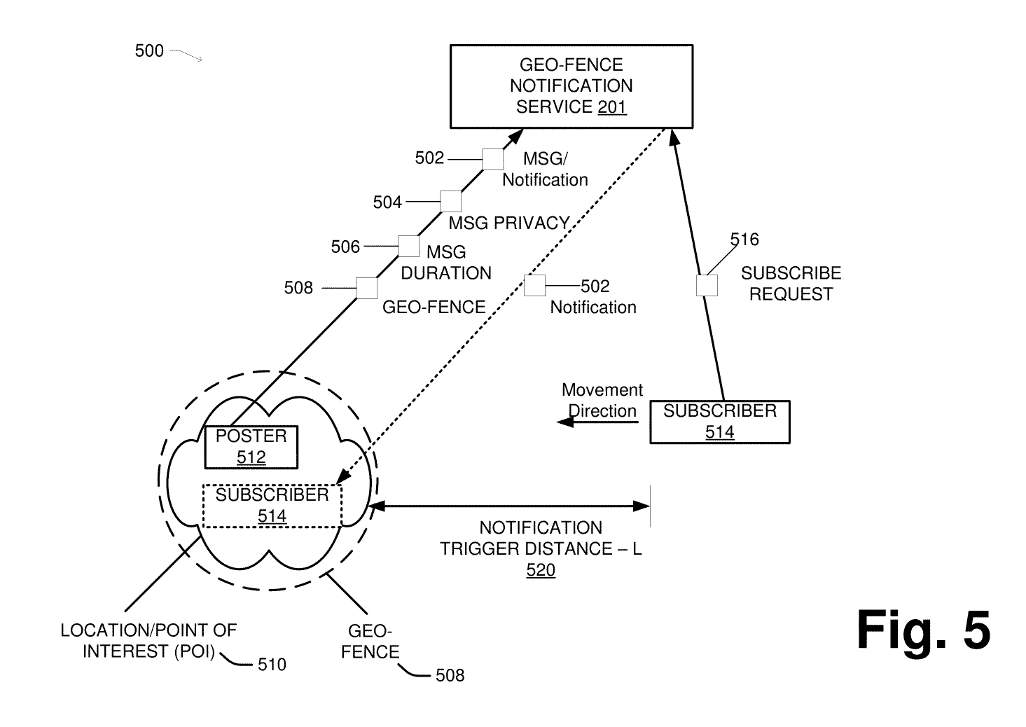

FIG. 5 is a diagram illustrating functionalities associated with a posting user and a subscribing user of a geo-fence notification service, in accordance with one or more embodiments. Referring to FIGS. 4-5, the following are example functionalities associated with a posting user (or poster) 512 in a network environment 500 using a geo-fence notification service (GFNS) 201. The poster 512 may be at a geographic location (or POI) 510 (e.g., a restaurant or another public venue). The poster 512 may have a profile (e.g., 402) maintained by the GFNS 201. The poster 512 may decide to post a notification or message 502 (e.g., restaurant review). The GFNS 201 may store the notification 502 within the poster's profile 402. The poster 512 may identify the POI 510 (e.g., select the POI from a mapping application or from another location-based application platform). After the POI 510 is identified and selected (e.g., using a computing device 102), the poster 512 may set up (or create) a geo-fence 508 associated with the POI 510. Even though the geo-fence 508 is illustrated as completely surrounding the POI 510, the geo-fence 508 may be adjusted (e.g., the diameter of the dashed-line circle of the geo-fence 508 may be adjusted at the time the geo-fence 508 is created). The geo-fence 508 may also be stored as part of the profile 402 and may be associated with the notification 502. The poster 512 may also designate a privacy setting 504 (e.g., the notification 502 may be designated as private) and a duration 506 (e.g., one week) for the notification 502.

In some embodiments, the poster 512 may post the notification 502 and the geo-fence 508 while physically being at the POI 510. However, in other embodiments, the poster 512 may post the notification 502 and the geo-fence 508 while being at a location different than the POI 510 (e.g., the poster 512 may post after coming home from visiting the POI 510). In this instance, the poster 512 may select the POI 510 from, e.g., a mapping application or by using another type of location-based application platform allowing for selection of a geographic location and/or a POI.

Referring to FIGS. 4-5, the following are example functionalities associated with a subscribing user (or subscriber) 512 in the network environment 500 using the geo-fence notification service (GFNS) 201. A subscriber 514 may be moving (e.g., walking) towards the POI 510. When the subscriber reaches a notification trigger distance (L) 520 from an existing geo-fence 508 associated with a public message 502, the notification 502 may be automatically communicated to the subscriber 514 (and displayed at a computing device used by the subscriber). In other embodiments, the notification 502 (with a public privacy setting 504) may be automatically communicated to the subscriber 514 after the subscriber 514 enters the corresponding geo-fence 508 associated with the notification 502. For example, a computing device used by the subscriber 514 may periodically communicate with the GFNS 201 and obtain information about available geo-fences (e.g., download geo-fence information and track the geo-fence associated with notifications that have public privacy setting). The subscriber's computing device (e.g., 102) may detect a geo-fence enter event (or detect there is notification trigger distance 520 between the subscriber's device and the geo-fence 508), and may request (or acquire) the associated notification 502 for display at the subscriber device.

In yet another embodiment, the notification 502 may have a private privacy setting 504. In this instance, the subscriber 514 may send a subscribe request 516 to the GFNS 201 and subscribe to geo-fence based notifications associated with the poster 512. The computing device (e.g., 102) used by the subscriber 514 may periodically communicate with the GFNS 201 and obtain information about available geo-fences (e.g., verify subscription to the profile 402 of poster 512, download geo-fence information and track one or more of the geo-fences associated with notifications that have private privacy setting). Upon satisfaction of the trigger distance or entry of the tracked geo-fence, the computing device of subscriber 514 may acquire and automatically display (e.g., at a display of the subscriber's device) a notification corresponding to the tracked geo-fence.

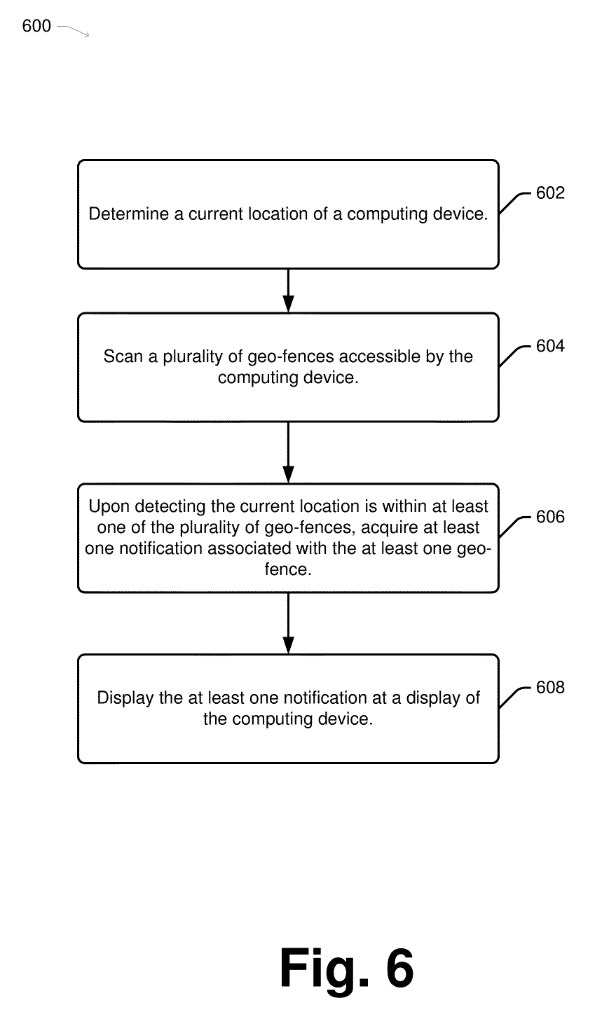

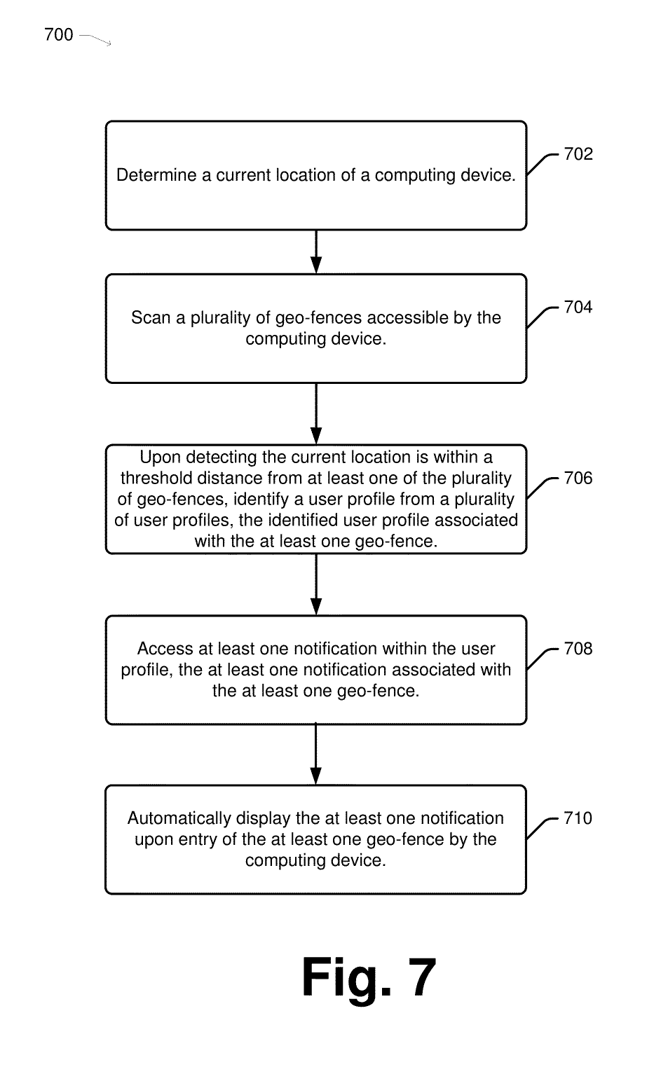

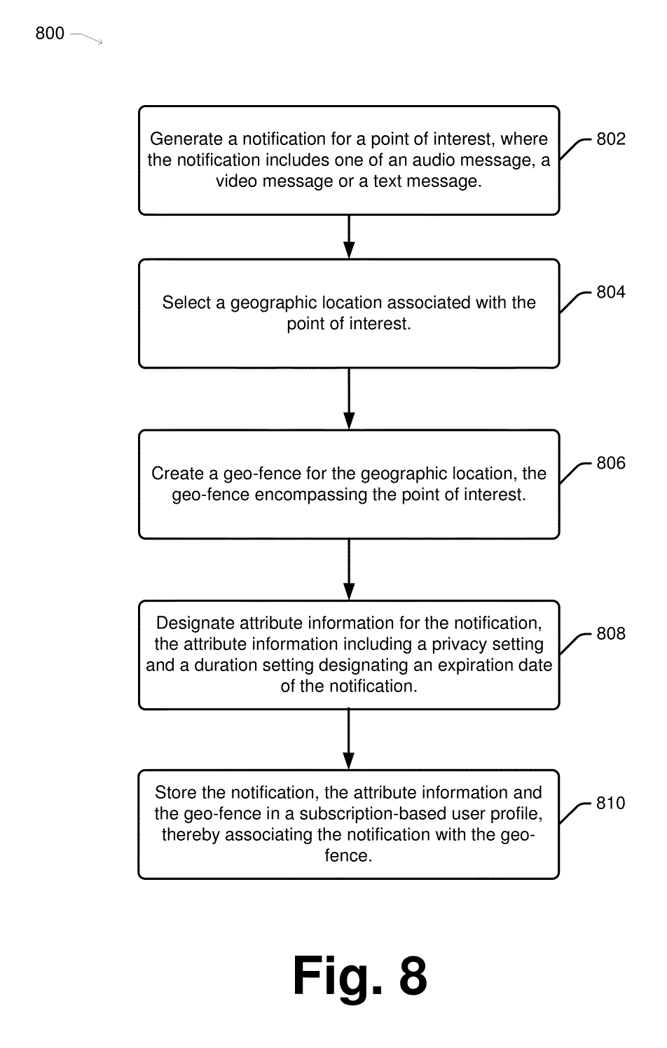

FIGS. 6-8 are flow diagrams illustrating example processing of geo-fence related notifications, in accordance with one or more embodiments. Referring to FIGS. 4-6, the example method 600 may start at 602, when a current location of a computing device may be determined. For example, the device 102 may determine a current location using the application processor 203 and/or the GNSS hardware 206. At 604, a plurality of geo-fences accessible by the computing device may be scanned. For example, the computing device 102 may subscribe to the poster profile 402 and may scan the plurality of available geo-fences 414, . . . , 416. At 606, upon detecting the current location is within at least one of the plurality of geo-fences, at least one notification associated with the at least one geo-fence may be acquired. For example, the device 102 may detect that its current location is within geo-fence 416. A corresponding notification 412 may then be acquired by the device 102. At 608, the at least one notification may be displayed at a display (e.g., 1154) of the computing device (e.g., 1100 which may be similar to device 102).

Referring to FIGS. 4-5 and 7, the example method 700 may start at 702, when a current location of a computing device may be determined. For example, the device 102 may determine a current location using the application processor 203 and/or the GNSS hardware 206. At 704, a plurality of geo-fences accessible by the computing device may be scanned. For example, the computing device 102 may scan a plurality of available geo-fences 414, . . . , 416 associated with notifications that have public privacy setting (e.g., device 102 may access the GFNS 201 and may download for tracking one or more geo-fences from one or more poster profiles, where the geo-fences may be available for download/tracking without a subscription since the associated notifications have public privacy setting). At 706, upon detecting the current location is within a threshold distance from at least one of the plurality of geo-fences, the computing device may identify a user profile from a plurality of user profiles. For example, the computing device 102 may be tracking geo-fence 414, and upon entry of the geo-fence 414, the device 102 may contact the GFNS 201 and identify profile 402 as the poster's profile associated with the geo-fence 414. At 708, at least one notification within the user profile may be accessed, the at least one notification associated with the at least one geo-fence. For example, the device 102 may access the notification 410, which is associated with the geo-fence 414. At 710, the device 102 may automatically display the at least one notification (e.g., 410) upon entry of the at least one geo-fence (e.g., 414) by the computing device.

Referring to FIGS. 5-6 and 8, the example method 800 may start at 802, when a notification for a point of interest may be generated (e.g., the poster 512 may post a notification 502 about POI 510). The notification 502 may include one of an audio message, a video message or a text message. At 804, a geographic location associated with the point of interest may be selected (e.g., the poster 512 may use a computing device (e.g., similar to 102) to designate/select the geographic location of the POI 510 (e.g., select as a “current location” from a mapping application or manually enter the POI location). At 806, a geo-fence for the geographic location may be created (e.g., the geo-fence 508 encompassing the point of interest 510 may be created). At 808, attribute information for the notification (e.g., 502) may be designated. The attribute information may include a privacy setting (e.g., 504), which may designate the notification (502) as a private notification or a public notification. The attribute information may also include a duration setting (e.g., 506) designating an expiration date of the notification. At 810, the notification (502), the attribute information (e.g., 504-506) and the geo-fence (508) may be stored in a subscription-based user profile (e.g., 402), thereby associating the notification with the geo-fence.

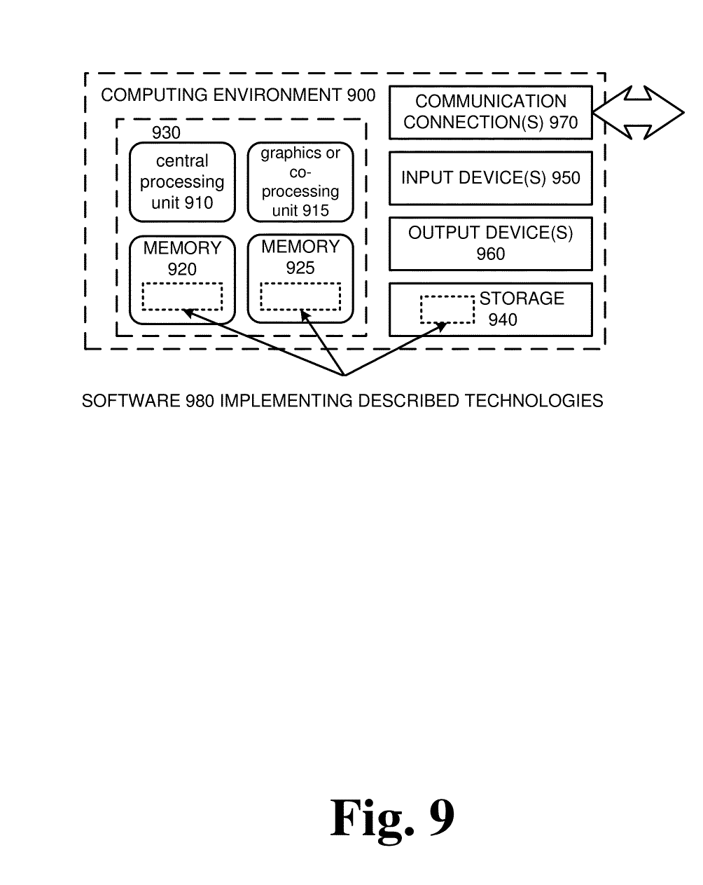

FIG. 9 is a diagram of an example computing system, in which some described embodiments can be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may also have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

FIG. 10 illustrates a generalized example of a suitable cloud-supported environment 1000, in which described embodiments, techniques, and technologies may be implemented. In the example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050), while other tasks (e.g., storage of data to be used in subsequent processing) can be performed in the cloud 1010.

In example environment 1000, the cloud 1010 provides services for connected devices 1030, 1040, 1050 with a variety of screen capabilities. Connected device 1030 represents a device with a computer screen 1035 (e.g., a mid-size screen). For example, connected device 1030 could be a personal computer such as desktop computer, laptop, notebook, netbook, or the like. Connected device 1040 represents a device with a mobile device screen 1045 (e.g., a small size screen). For example, connected device 1040 could be a mobile phone, smart phone, personal digital assistant, tablet computer, and the like. Connected device 1050 represents a device with a large screen 1055. For example, connected device 1050 could be a television screen (e.g., a smart television) or another device connected to a television (e.g., a set-top box or gaming console) or the like.

One or more of the connected devices 1030, 1040, and/or 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Geo-fence based notification services can be provided by the cloud 1010 through geo-fence notification service (GFNS) 1020, or through other providers of online services (not depicted). The GFNS 1020 may have functionalities similar to the GFNS 201 as described herein. For example, cloud services can be customized to the screen size, display capability, and/or touchscreen capability of a particular connected device (e.g., connected devices 1030, 1040, and/or 1050).

In the example environment 1000, the cloud 1010 provides one or more of the technologies and solutions described herein to the various connected devices 1030, 1040, and/or 1050 using, at least in part, the GFNS 1020.

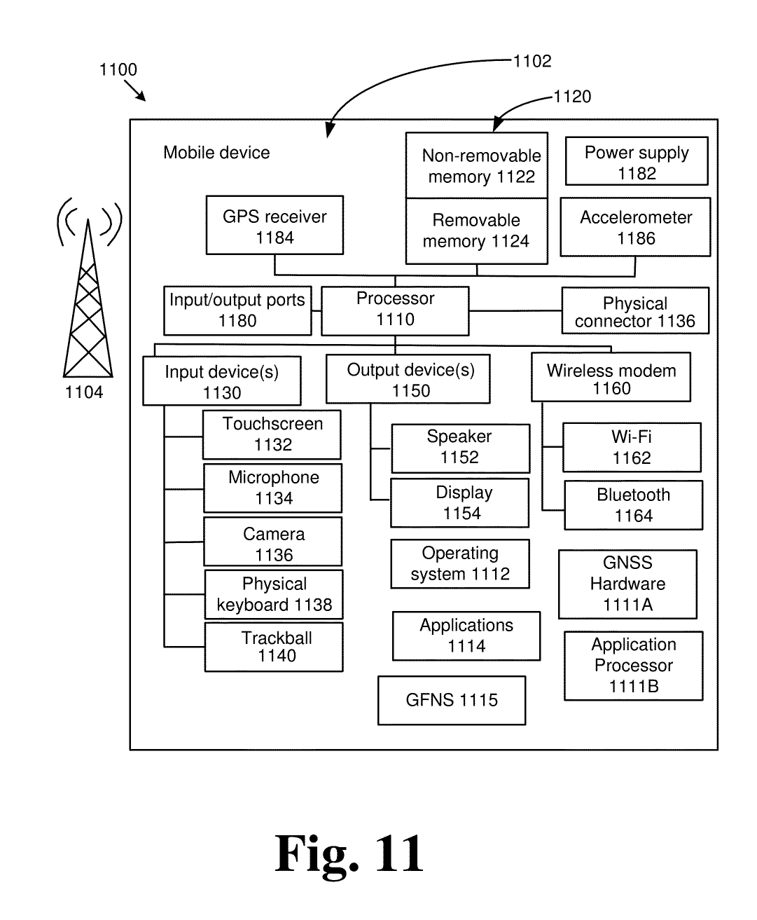

FIG. 11 is an example mobile device that can be used in conjunction with the technologies described herein. Referring to FIG. 11, the example mobile device 1100 may include a variety of optional hardware and software components, shown generally at 1102. Any components 1102 in the mobile device 1100 can communicate with any other component, although not all connections are shown, for ease of illustration. The mobile device 1100 can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application. Functionality 1113 for accessing an application store can also be used for acquiring and updating application programs 1114.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140, and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye , and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands. Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

In an example embodiment of the disclosure, the mobile device 1100 may further include a GNSS hardware 1111A and an application processor 1111B, which may be separate from or implemented as part of the device processor 1110. Furthermore, the mobile device 1100 may include a GFNS 1115 which may perform one or more of the functionalities of GFNS 201 as described herein.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 10, computer-readable storage media include memory 1020 and 1025, and storage 1040. By way of example and with reference to FIG. 11, computer-readable storage media may include memory and storage 1120, 1122, and 1124. The term “computer-readable storage media” does not include signals and carrier waves. In addition, the term “computer-readable storage media” does not include communication connections (e.g., 1070, 1160, 1162, and 1164).

In accordance with an example embodiment of the disclosure, a method may include tracking one or more geo-fences using a GNSS (e.g., GPS) hardware processor within a computing device. The tracking may use at least one GNSS (e.g., GPS) signal. State changes of the one or more geo-fences during the tracking may be saved in a shared state database. The shared state database may be shared between the GNSS hardware processor and an application processor within the computing device. Upon detecting a deterioration of the at least one GNSS signal, tracking the one or more geo-fences using the GNSS hardware processor may be switched to tracking the one or more geo-fences using the application processor. After the switching, an initial state of each of the one or more geo-fences may be set using states currently stored in the shared state database prior to the switching.

In accordance with another example embodiment of the disclosure, a computing device may include a GNSS (e.g., GPS) hardware processor configured to track one or more geo-fences using at least one GNSS (e.g., GPS) signal; an application processor configured to take over tracking the one or more geo-fences upon deterioration of the at least one GNSS signal; and a shared state database configured to store state changes of the one or more geo-fences during the tracking. The shared state database may be shared between the GNSS hardware processor and the application processor. Upon switching from tracking the one or more geo-fences using the GNSS hardware processor to tracking the one or more geo-fences using the application processor, the application processor may be operable to set an initial state of each of the one or more geo-fences using states currently stored in the shared state database prior to the switching. Upon detecting an improvement of the at least one GNSS signal, tracking the one or more geo-fences using the application processor may be switched to tracking the one or more geo-fences using the GNSS hardware processor. After the switching back, an initial state of each of the one or more geo-fences may be set using the states currently stored in the shared state database prior to the switching back.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computer-implemented method for processing geo-fence related notifications, comprising:
determining a current location of a computing device;
scanning a plurality of geo-fences accessible by the computing device;
upon detecting the current location is within at least one of the plurality of geo-fences, acquiring at least one notification associated with the at least one geo-fence, the at least one notification stored in a user profile of a user posting the at least one notification; and
displaying the at least one notification at a display of the computing device.

2. The method according to claim 1, wherein:
the current location is within a threshold distance of a point of interest; and
the at least one notification provides information about the point of interest.

3. The method according to claim 2, wherein the at least one notification comprises a consumer review about the point of interest.

4. The method according to claim 1, comprising:
automatically providing an alert at the computing device that the acquired at least one notification is available for display.

5. The method according to claim 1, wherein the plurality of geo-fences comprise at least a first portion of public geo-fences that are accessible without user authentication, and at least a second portion of private geo-fences that are accessible upon user authentication.

6. The method according to claim 5, comprising:
providing authentication information authorizing access to the second portion of private geo-fences.

7. The method according to claim 6, comprising:
authorizing access to the user profile based on the authentication information, the user profile associated with the at least one geo-fence and the at least one notification.

8. The method according to claim 1, comprising:
accessing the user profile associated with the at least one geo-fence.

9. The method according to claim 8, comprising:
verifying the computing device has crossed the at least one geo-fence.

10. The method according to claim 9, comprising:
acquiring the at least one notification from the user profile, upon successful verification the computing device has crossed the at least one geo-fence.

11. One or more computer-readable media selected from the group consisting of: volatile memory, non-volatile memory, magnetic disk storage, magnetic tape storage, CD-ROM, DVD, and Blu-Ray disc, the one or more computer-readable media having instructions stored thereon for executing a method for processing geo-fence related notifications, the stored instructions comprising:
instructions to determine a current location of a computing device;
instructions to scan a plurality of available geo-fences accessible by the computing device;
instructions to, upon detecting the current location is within a threshold distance from at least one of the plurality of geo-fences:
identify a user profile from a plurality of user profiles, the identified user profile associated with the at least one geo-fence, the user profile comprising a plurality of notifications for the at least one geo-fence; and
access at least one notification of the plurality of notifications within the user profile, the at least one notification associated with the at least one geo-fence; and
automatically display the at least one notification upon entry of the at least one geo-fence by the computing device.

12. The one or more computer-readable media according to claim 11, further including:
instructions to provide subscription verification information for verifying a subscription to the user profile associated with the at least one geo-fence.

13. The one or more computer-readable media according to claim 12, wherein the subscription verification information comprises a desired rating and the stored instructions further include:
instructions to verify the user profile is associated with a rating that is at least as high as the desired rating.

14. The one or more computer-readable media according to claim 12, the stored instructions further including:
instructions to verify the subscription to the user profile based on the subscription verification information; and
instructions to receive the at least one notification upon successful verification of the subscription.

15. The one or more computer-readable media according to claim 12, the stored instructions further including instructions to receive the at least one notification upon:
successful verification of the subscription; and
detecting the computing device has entered the at least one geo-fence.

16. The one or more computer-readable media according to claim 11, the stored instructions further including:
instructions to access attribute information associated with the at least one notification.

17. The one or more computer-readable media according to claim 15, wherein the attribute information comprises:
a privacy setting, the privacy setting designating the at least one notification as one of a private notification or a public notification; and
a duration setting designating an expiration date of the at least one notification.

18. One or more computer-readable media selected from the group consisting of: volatile memory, non-volatile memory, magnetic disk storage, magnetic tape storage, CD-ROM, DVD, and Blu-Ray disc, the one or more computer-readable media having instructions stored thereon for executing a method for processing geo-fence related notifications, the stored instructions comprising:
instructions to generate a notification for a point of interest, wherein the notification comprises one of an audio message, a video message or a text message;
instructions to select a geographic location associated with the point of interest;
instructions to create a geo-fence for the geographic location, the geo-fence encompassing the point of interest;
instructions to designate attribute information for the notification, the attribute information comprising:
a privacy setting, the privacy setting designating the notification as a private notification or a public notification; and
a duration setting designating an expiration date of the notification; and
instructions to store the notification, the attribute information and the geo-fence in a subscription-based user profile, thereby associating the notification with the geo-fence.

19. The one or more computer-readable media according to claim 18, wherein the attribute information further comprises:
a user rating for an owner of the user profile, the user rating associated with at least another notification in connection with at least another geo-fence available for access within the user profile.

20. The one or more computer-readable media according to claim 18, the stored instructions further including:
instructions to receive current location information of a computing device;
instructions to receive subscription verification information for verifying a subscription to the user profile; and
instructions to, upon successful verification of the subscription to the user profile and the current location information is within the geo-fence, provide the notification to the computing device.
